(19) United States
(12) Patent Application Publication
(10) Pub. No.: US 2026/0010419 A1
(43) Pub. Date: Jan. 8, 2026

(54) SERVICE COOPERATION DEVICE AND SERVICE COOPERATION METHOD

(71) Applicant: Mitsubishi Electric Corporation, Tokyo (JP)

(72) Inventor: Shuhei FUJITA, Tokyo (JP)

(73) Assignee: Mitsubishi Electric Corporation, Tokyo (JP)

(21) Appl. No.: 19/128,620

(22) PCT Filed: Dec. 9, 2022
(86) PCT No.: PCT/JP2022/045418

§ 371 Date: May 9, 2025

(51) Int. Cl. G06F 9/54

(52) U.S. Cl. CPC G06F 9/542

(57) ABSTRACT

It is an object of the present disclosure to automatically start a service cooperating with an application service by using a data model. A service cooperation device includes a data model creation unit for creating a data model that defines data handled by an application service operating in cooperation with a plurality of services and a relation among the plurality of pieces of data, an event detection unit for detecting an event which has occurred in the data defined by the data model on the data model management unit, and a service starting unit for giving the data in which the event has been detected to a corresponding service which is a service associated in advance with the data among the plurality of services, to thereby start the corresponding service.

### TECHNICAL FIELD

The present disclosure relates to cooperation of a plurality of services constituting an application service.

### BACKGROUND ART

Some of application services operate in cooperation with any other service. As a method for smoothly performing such cooperation, it is considered to use a data model relating to data used in the application service and other services, to thereby automatically start the service.

Patent Document 1 discloses an information processing device which includes an origin extraction means for extracting an “origin” which is information on a generating relation of data in target information including the data and a program used for processing the data, an order extraction means for extracting an order of a “link” which is a relation between the data and the program, and an influence range investigation means for specifying an influence range of a first program on the basis of the origin and the order.

### PRIOR ART DOCUMENTS

### Patent Document(s)

[Patent Document 1] Japanese Patent Application Laid Open Gazette No. 2018-45508.

### SUMMARY

### Problem to be Solved by the Invention

The information processing device disclosed in Patent Document 1 extracts the relation between the data and the program, and the extracted information is used to analyze the influence range in a software upgrade and is not used to start a service in accordance with an event. In other words, the information processing device disclosed in Patent Document 1 is not used to automatically start the service by using the data model.

The present disclosure is intended to solve the above problem, and it is an object of the present disclosure to automatically start a service cooperating with an application service by using a data model.

### Means to Solve the Problem

The present disclosure is intended for a service cooperation device, and the service cooperation device includes a data model creation unit for creating a data model that defines data handled by an application service operating in cooperation with a plurality of services and a relation among the plurality of pieces of data, a data model management unit for storing the data model and the data handled by the application service, an event detection unit for detecting an event which has occurred in the data defined by the data model on the data model management unit, and a service starting unit for giving the data in which the event has been detected to a corresponding service which is a service associated in advance with the data among the plurality of services, to thereby start the corresponding service.

### Effects of the Invention

According to the service cooperation device of the present disclosure, it is possible to automatically start a corresponding service in accordance with an event of data defined by a data model.

These and other objects, features, aspects and advantages of the present disclosure will become more apparent from the following detailed description of the present disclosure when taken in conjunction with the accompanying drawings.

### BRIEF DESCRIPTION OF DRAWINGS

FIG. 1 is a block diagram showing a configuration of a service cooperation device;

FIG. 2 is a diagram showing a flow of services in an on-demand ride-hailing service and data required by each service;

FIG. 3 is a diagram showing a data model represented by nodes and edges;

FIG. 4 is a diagram showing a detailed example of the data model of the on- demand ride-hailing service;

FIG. 5 is a diagram used for explaining an operation of an event detection unit;

FIG. 6 is a diagram showing a substance of the data model;

FIG. 7 is a diagram showing an example of one-to-one correspondence between a data element and a service;

FIG. 8 is a diagram showing an example of N-to-one correspondence between a data element and services;

FIG. 9 is a diagram showing an example of one-to-one correspondence between a data element and a service with a start condition of the service;

FIG. 10 is a diagram showing a flow of detection of an event and starting of a service;

FIG. 11 is a flowchart showing an operation of the service cooperation device;

FIG. 12 is a diagram showing a hardware configuration of the service cooperation device; and

FIG. 13 is a diagram showing a hardware configuration of the service cooperation device.

### DESCRIPTION OF EMBODIMENT(S)

### A. The First Preferred Embodiment

### A-1. Overview

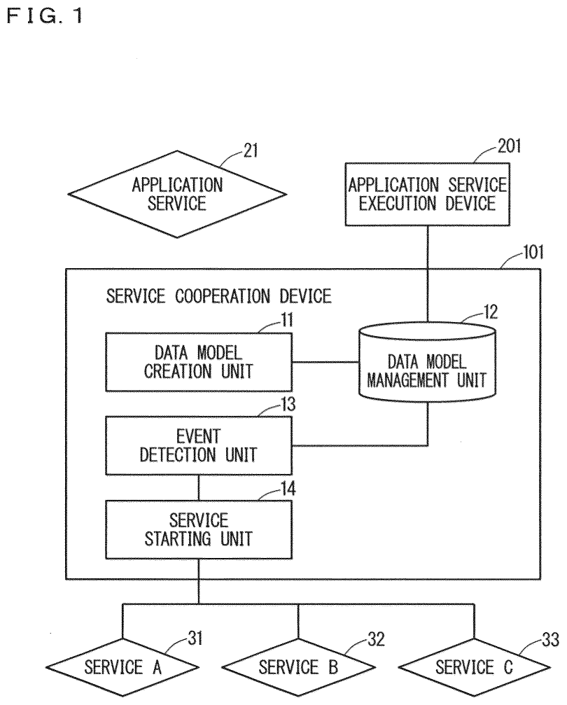

FIG. 1 is a block diagram showing a configuration of a service cooperation device 101 in accordance with a first preferred embodiment. The service cooperation device 101 makes a cooperation between an application service 21 executed by an application service execution device 201 and other services required to execute the application service 21. The application service 21 is an ASP service provided by ASP (Application Service Provider). The application service 21 is implemented by cooperating with a plurality of services. In the exemplary case of FIG. 1, the application service 21 is implemented by cooperating with services A, B, and C.

The service cooperation device 101 is configured to include a data model creation unit 11, a data model management unit 12, an event detection unit 13, and a service starting unit 14.

The data model creation unit 11 creates a data model 51 in accordance with an input of an administrator of the application service 21. The data model 51 defines data handled by the application service 21 and a relation among the data.

The data model management unit 12 manages the data model 51 created by the data model creation unit 11. When the application service execution device 201 executes the application service 21, an event of the data defined by the data model 51 occurs. The event of the data includes at least any one of generation, update, and deletion of the data. When a generation event of the data occurs, the generated data are stored into the data model management unit 12. When an update event of the data occurs, already-existing data are updated in the data model management unit 12. Further, when a deletion event of the data occurs, the data are deleted in the data model management unit 12.

The event detection unit 13 detects the event of the data defined by the data model 51 on the basis of a change of the data in the data model management unit 12.

The service starting unit 14 specifies a service (hereinafter, referred to as a “corresponding service”) corresponding to the data in which the event has been detected, among the services A31, B32, and C33, and gives the data element in which the event has been detected to the corresponding service, to thereby start the corresponding service.

Each of the services A31, B32, and C33 is, for example, an end point whose URL (Uniform Resource Locator) is published. For each of these end points, determined in advance is an operation to be performed in accordance with inputted data. Starting a service means transmitting data determined in advance to the end point, or performing some communication therewith. By starting the service, the service is performed at the end point.

### A-2. Data Model Creation Unit 11 and Data Model Management Unit 12

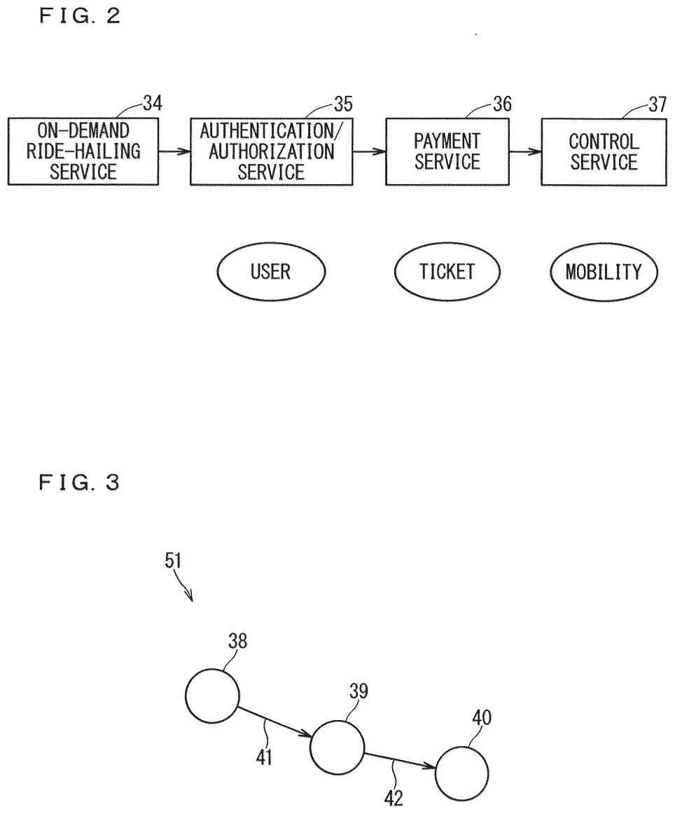

FIG. 2 shows a flow of services in performing an on-demand ride-hailing service 34 and data required by each service. Hereinafter, the on-demand ride-hailing service 34 is assumed to be an example of the application service 21. The on-demand ride-hailing service 34 cooperates with an authentication/authorization service 35, a payment service 36, and a control service 37. The authentication/authorization service 35, the payment service 36, and the control service 37 correspond to services A31, B32, and C33 shown in FIG. 1, respectively.

The on-demand ride-hailing service 34, the authentication/authorization service 35, the payment service 36, and the control service 37 are performed in this order. The authentication/authorization service 35 authenticates a user of the on-demand ride-hailing service 34 with an ID, a password, and the like. The data required by the authentication/authorization service 35 are the user. The payment service 36 is a service for paying a fare to a destination. The data required by the payment service 36 are the ticket. The control service 37 controls the mobility. In other words, the control service 37 is a service for allocating the mobility and transporting the user to the destination.

The data model creation unit 11 creates the data model that defines the data required by each service and a relation among the data and stores the data model into the data model management unit 12. FIG. 3 shows the data model 51 created by the data model creation unit 11. In the data model 51, for example, a graph database is used, and a relation of the data is represented by the nodes 38, 39, and 40 and edges 41 and 42.

The node 38 represents the “user” data required by the authentication/authorization service 35. The node 39 represents the “ticket” data required by the payment service 36. The node 40 represents the “mobility” data required by the control service 37. The nodes 38 and 39 are connected to each other with the edge 41, and the nodes 39 and 40 are connected to each other with the edge 42.

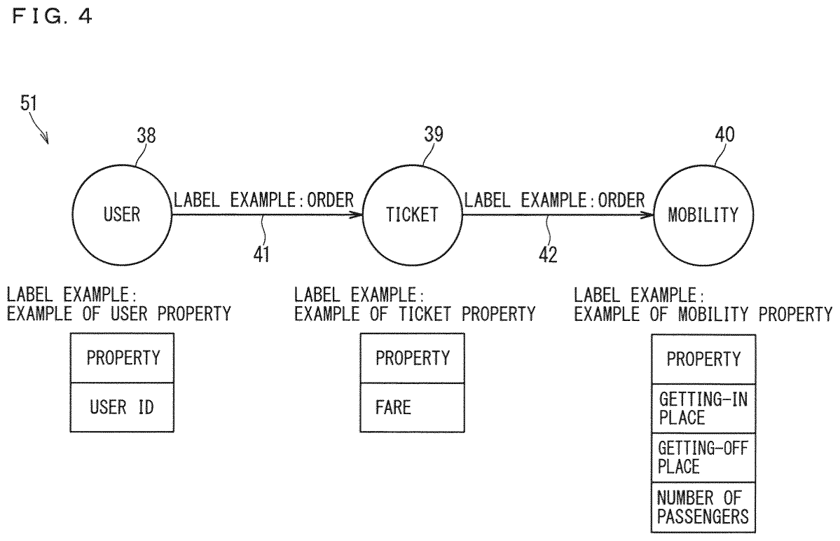

FIG. 4 shows a detailed example of the data model 51. Each of the nodes 38, 39, and 40 and the edges 41 and 42 constituting the data model 51 has a label. Further, each of the nodes 38, 39, and 40 and the edges 41 and 42 has a property as necessary.

As to the node 38 representing the data required by the authentication/authorization service 35, the label is “user” and the property is “user ID”. As to the node 39 representing the data required by the payment service 36, the label is “ticket” and the property is “fare”. As to the node representing the data required by the control service 37, the label is “mobility” and the property is “getting-in place”, “getting-off place”, or “the number of passengers”. The label of the edge is, for example, “order”. The application service execution device 201 processes the data in the order set in the data model 51. The data model is positioned just as metadata, and has no property value.

### A-3. Event Detection Unit 13

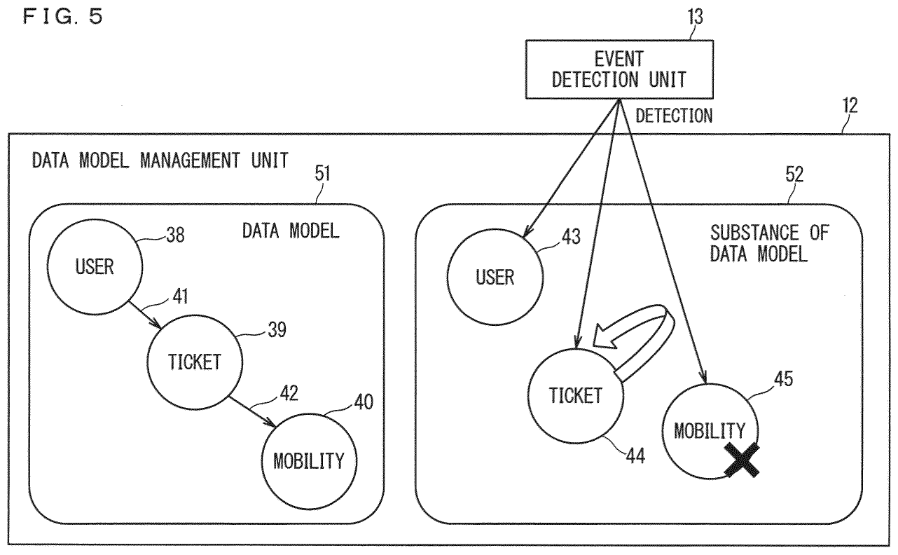

FIG. 5 is a diagram used for explaining an operation of the event detection unit 13.

In the data model management unit 12, stored are, besides the data model 51 created by the data model creation unit 11, actual data (hereinafter, referred to as a “substance 52 of the data model”) used by the application service 21. The application service execution device 201 executes the application service 21 and stores the data generated in the course into the data model management unit 12 as the substance 52 of the data model. Further, the data updated or deleted in the course of executing the application service 21 are updated or deleted also in the data model management unit 12.

The event detection unit 13 detects events occurring in the “user” data, the “ticket” data, and the “mobility” data in the substance 52 of the data model stored in the data model management unit 12. The event refers to at least any one of generation, update, and deletion of the data.

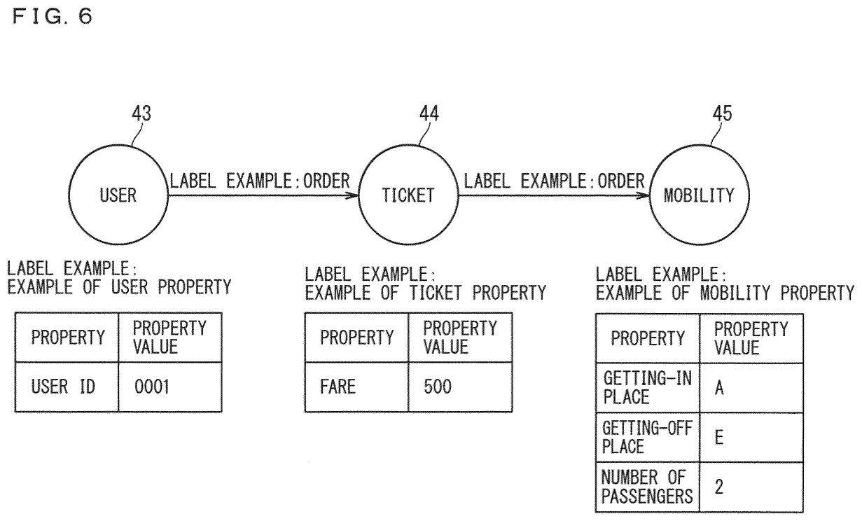

FIG. 6 is a diagram showing the substance 52 of the data model. Unlike the data model 51, the substance 52 of the data model has a property value. The node 43 of the “user” data, for example, have a property value “0001” of the property “user ID”. Further, the node 44 of the “ticket” data have a property value “500” of the property “fare”. Furthermore, the node 45 of the “mobility” data have a property value “A” of the property “getting-in place”, a property value “E” of the property “getting-off place”, and a property value “2” of the property “the number of passengers”. The event detection unit 13 detects the event of the data in which the property value is written.

### A-4. Service Starting Unit 14

The service starting unit 14 specifies the corresponding service which is a service corresponding to the data in which the event has been detected, and gives the data to the corresponding service, to thereby start the corresponding service. The data are associated with the service in advance by the administrator, and the service starting unit 14 has correspondence information. Further, the data element and the service are not necessarily associated one-to-one with each other but may be associated one-to-N, N-to-one, or N-to-N with each other. Furthermore, the start condition of the service may be set.

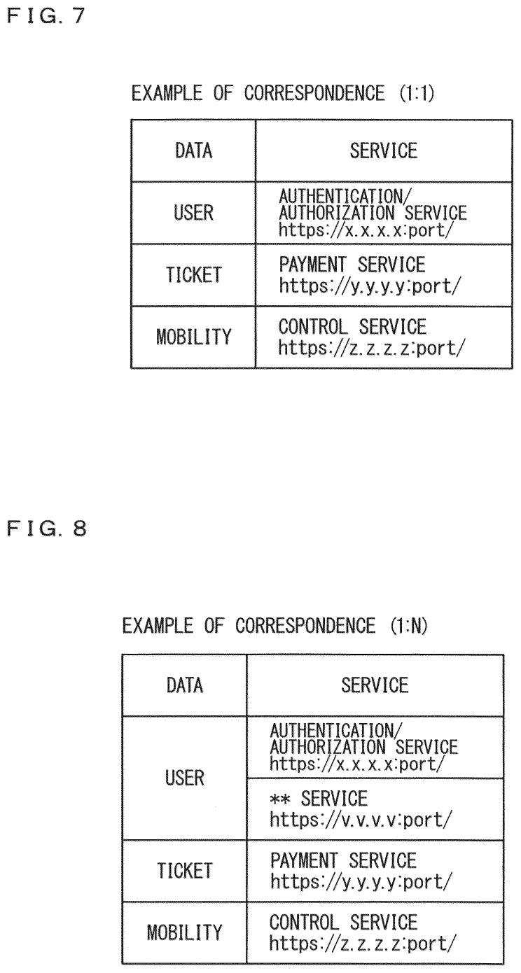

FIGS. 7 to 9 show examples of correspondence between the data elements and the services. FIG. 7 shows an example of one-to-one correspondence between a data element and a service. The “user” data are associated with the authentication/authorization service 35 (https://x.x.x.x:port/). Further, the “ticket” data are associated with the payment service (https://y.y.y.y:port/). Furthermore, the “mobility” data are associated with the control service (https://z.z.z.z:port/).

FIG. 8 shows an example of one-to-N correspondence between a data element and services. The “user” data are associated with the authentication/authorization service 35 (https://x.x.x.x:port/) and a VV service (https://v.v.v.v:port/). Further, the “ticket” data are associated with the payment service (https://y.y.y.y:port/). Furthermore, the “mobility” data are associated with the control service (https://z.z.z.z:port/).

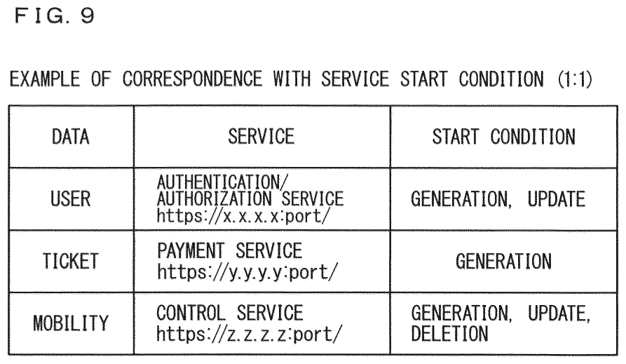

FIG. 9 shows an example of one-to-one correspondence between a data element and a service with the start condition of the service. In this exemplary case, the data element and the service are associated one-to-one with each other like in the exemplary case of FIG. 7 and further “generation or update” is set as the start condition of the authentication/authorization service 35. Specifically, when the event of generation or update occurs in the “user” data, the service starting unit 14 starts the authentication/authorization service 35. Further, “generation” is set as the start condition of the payment service 36. Specifically, when the event of generation occurs in the “ticket” data, the service starting unit 14 starts the payment service 36. Furthermore, “generation, update, or deletion” is set as the start condition of the control service 37. Specifically, when the event of generation, update, or deletion occurs in the “mobility” data, the service starting unit 14 starts the control service 37.

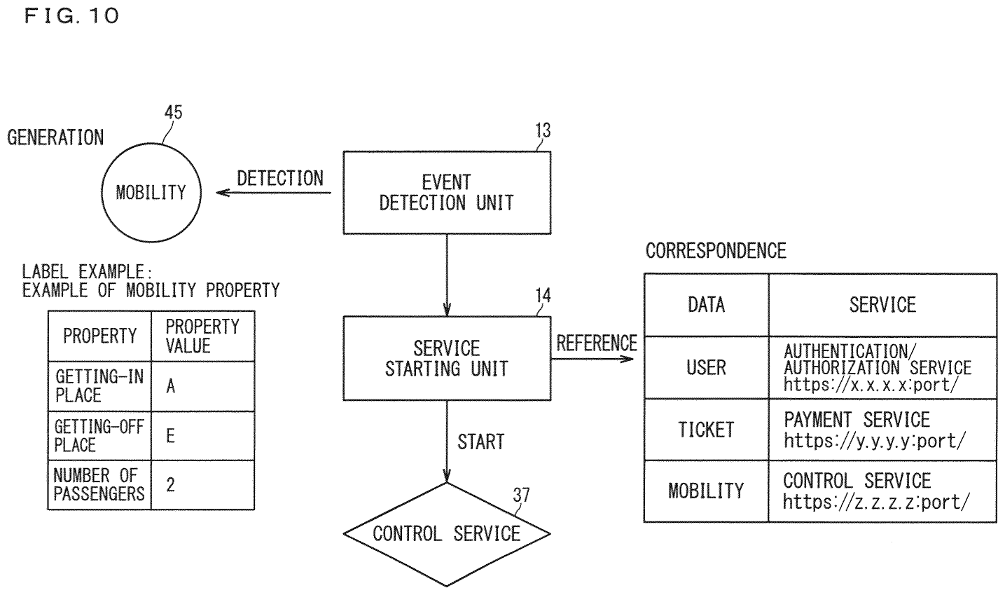

FIG. 10 is a diagram showing a flow of detection of the event and starting of the service. It is assumed that when the application service 21 executes the application service 21, the “mobility” data are generated. The “mobility” data have the property value “A” of the “getting-in place” property, the property value “E” of the “getting-off place” property, and the property value “2” of the “the number of passengers” property.

When the event detection unit 13 detects generation of the “mobility” data, the service starting unit 14 refers to the correspondence information between the data element and the service and gives the “mobility” data to the control service 37 (https://z.z.z.z:port/) which is a service corresponding thereto, to thereby start the control service 37. The control service 37 can thereby grasp the information required for ride-hailing, such as the getting-in place, the getting-off place, and the number of passengers.

### A-5. Flowchart

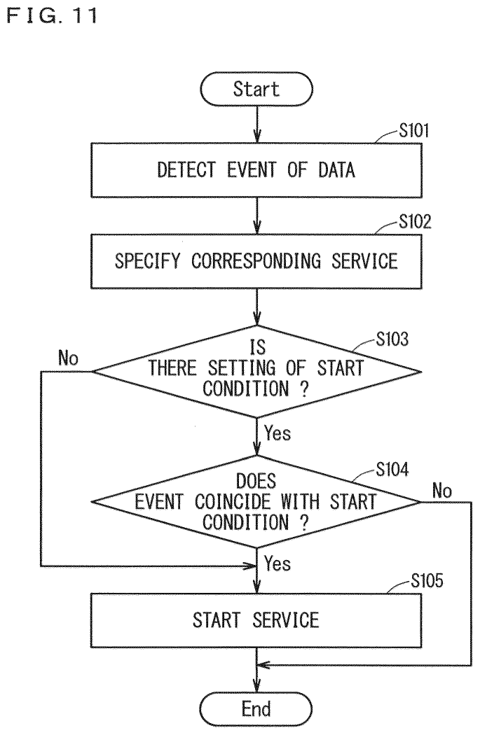

FIG. 11 is a flowchart showing an operation of the service cooperation device 101. As the advance preparation, the data model creation unit 11 creates the data model and the service starting unit 14 has the correspondence information between the data element and the service.

First, in Step S101, the event detection unit 13 detects the event of the data.

Next, in Step S102, the service starting unit 14 specifies the corresponding service of the data in which the event has occurred.

After that, in Step S103, the service starting unit 14 determines if there is a setting of the start condition. When there is no setting of the start condition, the service starting unit 14 starts the service in Step S105.

When there is a setting of the start condition in Step S103, the service starting unit 14 determines, in Step S104, if the event coincides with the start condition. When the event does not coincide with the start condition, the service starting unit 14 does not start the service but the process of the service cooperation device 101 is ended.

When the event coincides with the start condition in Step S104, the service starting unit 14 starts the service in Step S105, and the process of the service cooperation device 101 is ended.

### A-6. Variations

In the above description, the service starting unit 14 makes one-to-one correspondence between the data defined by the data model 51 and the service and specifies the corresponding service. The service starting unit 14, however, may abstract the data defined by the data model 51 and make correspondence between the abstracted data obtained by abstracting the data and the service, to thereby specify the corresponding service. When the data model 51 defines the user data, for example, the data on “human” obtained by abstracting the user data may be associated with a specific service X. Then, when the data on “human” are generated, the service starting unit 14 may start the specific service X corresponding to the data on “human”.

In the above description, after the event detection unit 13 detects that the event has occurred in the data, the service starting unit 14 starts the corresponding service. Before the event occurs in the data, however, the service starting unit 14 may start the corresponding service.

When the application service execution device 201 intends to generate the user data, for example, a generation request of the user data is transmitted to the service cooperation device 101, and the request is stored into the data model management unit 12. When the service cooperation device 101 makes a response indicating that the request is allowed to the application service execution device 201, the application service execution device 201 generates the user data.

With such a configuration, the event detection unit 13 detects the generation event of the user data in advance on the basis of the generation request of the user data stored in the data model management unit 12. Then, the service starting unit 14 can start the service corresponding to the user data before the user data are actually generated.

In the exemplary case of FIG. 9, the start condition of the corresponding service is set for each data defined by the data model 51. The start condition of the corresponding service may be freely set by a user. For example, a condition that the corresponding service is started when two pieces of data get together may be set.

As to the data in which the event of generation or update has occurred, the service starting unit 14 may have a determination criterion that is a condition set in advance, which a value of the data should satisfy, and may verify the validity of the data in light of the determination criterion. It is assumed, for example, that a determination criterion that a value of the new-generated data is not less than 5 and less than 50 is set in advance. The service starting unit 14 may start the corresponding service only when the service starting unit 14 verifies the data in which the event has occurred and determines that the value of the data is valid.

After the service starting unit 14 starts the corresponding service, the service starting unit 14 may associate the data which have served as a trigger to start the corresponding service with the corresponding service and starting time of the corresponding service and accumulate the data as the service start history. When some trouble occurs in the corresponding service, it thereby becomes possible to specify the data which is a cause of the trouble.

### A-7. Effects

The service cooperation device 101 in accordance with the first preferred embodiment includes the data model creation unit 11 for creating the data model 51 that defines data handled by the application service 21 operating in cooperation with the plurality of services A31, B32, and C33 and a relation among the plurality of pieces of data, the data model management unit 12 for storing the data model 51 and the data handled by the application service 21, the event detection unit 13 for detecting an event which has occurred in the data defined by the data model 51 on the data model management unit 12, and the service starting unit 14 for giving the data in which the event has been detected to a corresponding service which is a service associated in advance with the data among the plurality of services, to thereby start the corresponding service. Therefore, according to the service cooperation device 101, it is possible to automatically start the corresponding service in accordance with the event of the data defined by the data model and smoothly perform cooperation between the application service 21 and the other services. Further, it becomes possible to add a new service or change an already-existing service only by changing the definition of the data model without making any change on the service itself. Furthermore, with the definition of the data model, the starting order and the dependency among the services can be easily grasped and the maintainability is improved.

### B. Hardware Configuration

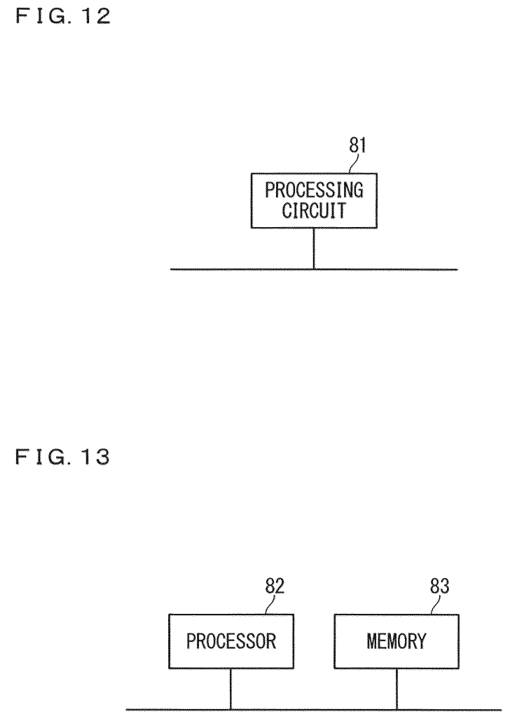

In the above-described service cooperation device 101, the data model creation unit 11, the data model management unit 12, the event detection unit 13, and the service starting unit 14 are implemented by the processing circuit 81 shown in FIG. 12. Specifically, the processing circuit 81 includes the data model creation unit 11, the data model management unit 12, the event detection unit 13, and the service starting unit 14 (hereinafter, referred to as “the data model creation unit 11 and the like)”. To the processing circuit 81, a dedicated hardware may be applied, or a processor which executes a program stored in a memory may be applied. As the processor, for example, used is a central processing unit, a processing unit, an arithmetic unit, a microprocessor, a microcomputer, a DSP (Digital Signal Processor), or the like.

When the processing circuit 81 is a dedicated hardware, the processing circuit 81 corresponds to, for example, a single circuit, a complex circuit, a programmed processor, a multiple programmed processor, an ASIC (Application Specific Integrated Circuit), an FPGA (Field Programmable Gate Array), or a combination of these circuits. Respective functions of the data model creation unit 11 and the like may be implemented by a plurality of processing circuits 81, or these functions may be collectively implemented by one processing circuit.

When the processing circuit 81 is a processor, the functions of the data model creation unit 11 and the like are implemented by a combination with software or the like (software, firmware, or software and firmware). The software or the like is described as a program and stored into a memory. As shown in FIG. 13, a processor 82 applied to the processing circuit 81 reads out and executes the program stored in a memory 83, to thereby implement the respective functions of the constituent elements. Specifically, the service cooperation device 101 includes the memory 83 which stores therein programs which are executed by the processing circuit 81 to consequently perform the step of causing the data model creation unit 11 to create the data model 51 that defines data handled by the application service 21 operating in cooperation with the plurality of services A31, B32, and C33 and a relation among the plurality of pieces of data, the step of causing the data model management unit 12 to store the data model 51 and the data handled by the application service 21, the step of causing the event detection unit 13 to detect an event which has occurred in the data defined by the data model 51 on the data model management unit 12, and the step of causing the service starting unit 14 to give the data in which the event has been detected to a corresponding service which is a service associated in advance with the data among the plurality of services, to thereby start the corresponding service. In other words, this program is executed to cause a computer to perform a procedure or a method of the data model creation unit 11 and the like. Herein, the memory 83 may be, for example, a nonvolatile or volatile semiconductor memory such as a RAM (Random Access Memory), a ROM (Read Only Memory), a flash memory, an EPROM (Erasable Programmable Read Only Memory), an EEPROM (Electrically Erasable Programmable Read Only Memory), or the like, a HDD (Hard Disk Drive), a magnetic disk, a flexible disk, an optical disk, a compact disk, a mini disk, or a DVD (Digital Versatile Disk) and a drive unit thereof, or the like, or every storage medium which can be used in the future.

The case has been described above where the respective functions of the data model creation unit 11 and the like are implemented by one of hardware and software or the like. This is, however, only one exemplary case, and there may be a case where some part of the data model creation unit 11 and the like is implemented by a dedicated hardware and the other part is implemented by software or the like. For example, there may be a case where the function of the data model creation unit 11 is implemented by the processing circuit as the dedicated hardware, and the respective functions of the constituent elements other than the data model creation unit 11 are implemented when the processing circuit 81 as the processor 82 reads and executes the programs stored in the memory 83.

As described above, the processing circuit can implement the above-described functions by hardware, software or the like, or a combination thereof. Further, the data model management unit 12 is formed of the memory 83.

Furthermore, the preferred embodiments may be freely combined, or may be changed or omitted as appropriate. The foregoing description is in all aspects illustrative. It is therefore understood that numerous modifications and variations which are not illustrated can be devised.

### EXPLANATION OF REFERENCE SIGNS

11 data model creation unit, 12 data model management unit, 13 event detection unit, 14 service starting unit, 21 application service, 31 service A, 32 service B, 33 service C, 34 on-demand ride-hailing service, 35 authorization service, 36 payment service, 37 control service, 38, 39, 40, 43, 44, 45 node, 41, 42 edge, 51 data model, 52 substance of data model, 81 processing circuit, 82 processor, 83 memory, 101 service cooperation device, 201 application service execution device

1. A service cooperation device, comprising:
a processor to execute a program; and
a memory to store the program which, when executed by the processor, performs processes of,
creating a data model that defines data handled by an application service operating in cooperation with a plurality of services and a relation among the plurality of pieces of data;
storing the data model and the data handled by the application service;
detecting an event which has occurred in the data defined by the data model; and
giving the data in which the event has been detected to a corresponding service which is a service associated in advance with the data among the plurality of services, to thereby start the corresponding service.

2. The service cooperation device according to claim 1, wherein the event includes at least any one of generation, deletion, and update of the data.

3. The service cooperation device according to claim 1, wherein
abstracted data obtained by abstracting the data defined by the data model is associated with the plurality of services, and
the corresponding service is a service corresponding to the abstracted data of the data in which the event has been detected, among the plurality of services.

4. The service cooperation device according to claim 1, wherein
the event is either generation or update of the data, and
the corresponding service is started only when a value of the data in which the event has been detected satisfies a condition set in advance.

5. The service cooperation device according to claim 1, wherein
a service start history associating the corresponding service with the data given to the corresponding service when the corresponding service is started, is accumulated.

6. A service cooperation method, comprising:
creating a data model that defines data handled by an application service operating in cooperation with a plurality of services and a relation among the plurality of pieces of data by a data model creation unit;
storing the data model and the data handled by the application service;
detecting an event which has occurred in the data defined by the data model; and
giving the data in which the event has been detected to a corresponding service which is a service associated in advance with the data among the plurality of services, to thereby start the corresponding service.
